(19) United States
(12) Patent Application Publication
(10) Pub. No.: US 2013/0031234 A1
(43) Pub. Date: Jan. 31, 2013

(54) METHODS AND APPARATUS TO COLLABORATIVELY MANAGE A CLIENT USING MULTIPLE SERVERS

(71) Applicant: Research In Motion Limited, Waterloo (CA)

(72) Inventors: Nicholas Patrick Alfano, Stratford-Upon-Avon (GB); Douglas Michael Gisby, Highland, IL (US); Axel Ferrazzini, Uccle (BE); Jason Lee Carter, Davie, FL (US); John Francis Holmes, Plantation, FL (US); Thomas Owen Parry, Cambridge (CA); Richard Enrique Lopez, Miami, FL (US)

(73) Assignee: RESEARCH IN MOTION LIMITED, Waterloo (CA)

(21) Appl. No.: 13/629,103

(22) Filed: Sep. 27, 2012

Related U.S. Application Data
(63) Continuation of application No. PCT/US11/29820, filed on Mar. 24, 2011.
(60) Provisional application No. 61/320,116, filed on Apr. 1, 2010.

(51) Int. Cl. G06F 15/173

(52) U.S. Cl. 709/223

(57) ABSTRACT

An example device includes a processor configured to execute an Open Mobile Alliance (OMA) Device Management (DM) server, wherein the OMA DM server uses or includes an interface to send communications directly to a second OMA DM server for delegating management of a DM client.

### FIELD OF THE DISCLOSURE

The present disclosure relates generally to network communications and, more particularly, to methods and apparatus to collaboratively manage or delegate management of a client.

### BACKGROUND

Mobile communications enable devices and/or users to communicate with one another through one or more wireless communication protocols using one or more services. In some mobile communication systems, mobile device services or operations are managed by service providers. For example, a service provider can provision client mobile devices for device management by one or more management servers of that service provider. The Open Mobile Alliance (OMA) group develops and defines guidelines or standards for implementing such server-client management relationships.

### BRIEF DESCRIPTION OF THE DRAWINGS

FIG. 1 depicts example mobile communication networks with device management servers that can implement device management control over a device management client in a mobile device.

FIG. 2 is an example device management architecture between the device management servers and the device management client of FIG. 1 showing different notification and protocol interfaces that can be used to establish multiple device management sessions between the device management servers and the device management client.

FIG. 3 is another example device management architecture that may be used to establish a third-party application server device management session with the device management client of FIG. 1 separately from other types of device management sessions.

FIG. 4 is an example device management control hierarchy data structure that specifies priorities associated with the device management servers of FIGS. 1-3 having device management control over a device management client of FIG. 1.

FIG. 5 is an example device management control function assignments data structure that specifies functions associated with respective ones of the device management servers of FIGS. 1-3.

FIG. 6 is an example device management server loads data structure that tracks the work loads of each of the device management servers of FIGS. 1-3 for use in balancing loads between the servers.

FIG. 7 depicts a flow diagram representative of an example process that may be implemented using computer readable instructions to establish multiple device management control sessions between the device management servers and the device management client of FIGS. 1-3 to collaboratively manage the device management client using multiple device management servers.

FIG. 8 depicts a block diagram of an example computing device that can be used to implement the example methods and apparatus described herein.

### DETAILED DESCRIPTION

Although the present application discloses example methods and apparatus including, among other components, software executed on hardware, it should be noted that such methods and apparatus are merely illustrative and should not be considered as limiting. For example, any or all of these hardware and software components could be embodied exclusively in hardware, exclusively in software, exclusively in firmware, or in any combination of hardware, software, and/or firmware. Accordingly, while example methods and apparatus are described herein, persons having ordinary skill in the art will readily appreciate that the examples provided are not the only ways to implement such methods and apparatus.

The example methods and apparatus described herein can be used to establish device management (DM) control (or management) sessions between multiple DM servers and a DM client such that, for example, the DM client can be collaboratively managed by the multiple DM servers at the same time. The example methods and apparatus described herein can be used in connection with mobile communication devices, mobile computing devices, or any other device capable of accessing information over a mobile communications network. Such devices, also referred to as user equipment (UE), clients, or terminals, may include mobile smart phones (e.g., a BlackBerry® smart phone), personal digital assistants (PDA), laptop/notebook/netbook computers, tablet computers, desktop computers, etc.

The example methods and apparatus described herein can be implemented in connection with the Open Mobile Alliance (OMA) specifications related to device management processes, which, among other things, specify protocols and mechanisms to manage mobile devices including specifying configurations to access services and management of software on mobile devices. The example methods and apparatus may additionally or alternatively be implemented in connection with other specifications, methods, or techniques to manage services and software on mobile devices.

The example methods and apparatus described herein enable collaboratively managing a DM client by multiple DM servers and transferring (or delegating) management of a DM client from one or more DM servers to one or more other DM servers. Such collaborative DM control and management delegation over a DM client is implemented by enabling DM servers to interact directly with each other as described below based on a server-server protocol interface and rules or permissions that specify how a DM client interacts with multiple DM servers. The example methods and apparatus described herein can be used to implement architectures for implementing multiple management authorities (e.g., DM servers) that define how the management authorities interconnect and interwork with a DM client and how a DM server may coordinate management of a DM client with one or more other DM servers to collaboratively manage the DM client.

In enabling DM servers to directly connect and interwork with each other as described herein, the example methods and apparatus also enable establishing hierarchies (e.g., priority hierarchies) of DM client management control between multiple DM servers, establishing agreements for partial or shared control of DM clients between multiple DM servers, extending user services and business-to-business services, load sharing among multiple DM servers, and maintaining a fault-tolerant architecture between the multiple DM servers.

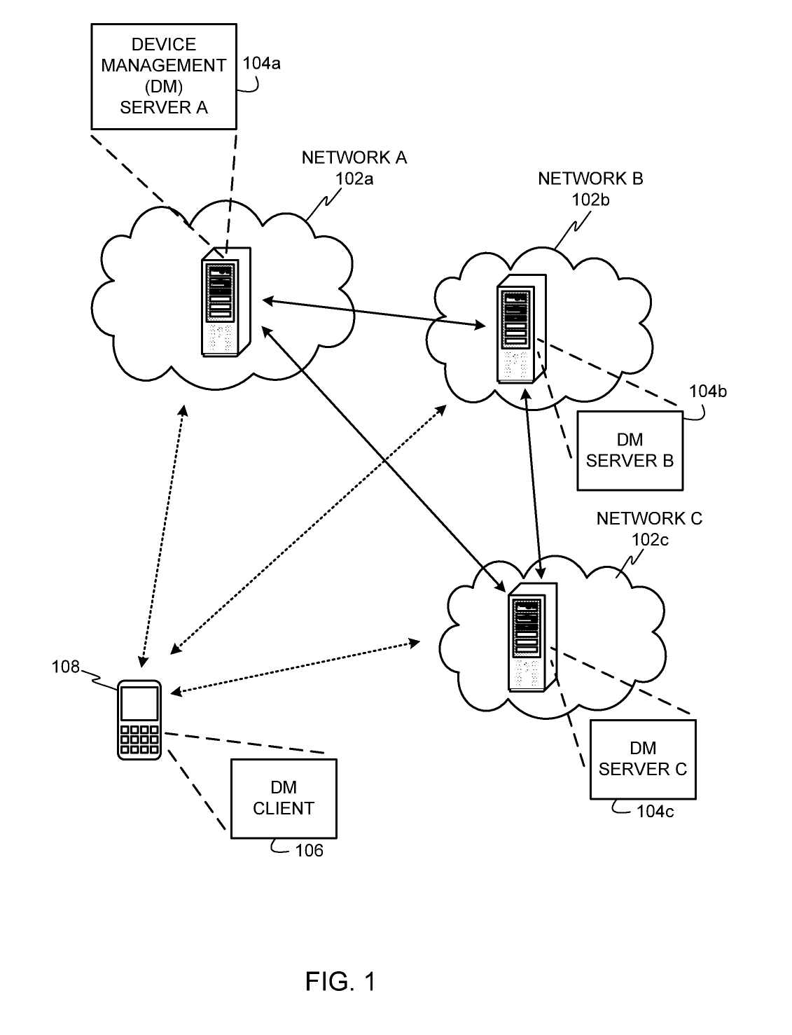

Turning to FIG. 1, example mobile communication networks A 102a, B 102b, and C 102c (e.g., cellular or other wireless networks) have respective DM servers A 104a, B 104b, and C 104c that can manage or otherwise implement DM control over a DM client 106 of a mobile device 108. In the illustrated example, the DM client 106 is a software component in the mobile device 108 (e.g., a managed device) that interprets commands, executes appropriate actions in the mobile device 108 and sends back relevant responses to an issuing management server (e.g., one of the DM servers 104a, 104b, and 104c). Also in the illustrated example, a DM server is a software component that issues management commands to DM clients. In some example implementations, each of the DM servers 104a-c manages devices in a respective geographic area (e.g., in a respective country, territory, state, etc.) or for a respective network operator (e.g., entities that operate/manage or are otherwise associated with networks A, B, and C 102a-c). In other example implementations, two or more of the DM servers 104a-c can manage devices in the same geographic area for the same or different network operators. In any case, the DM servers 104a-c can collaboratively manage a single DM client (e.g., the DM client 106) or delegate management of the DM client as described herein.

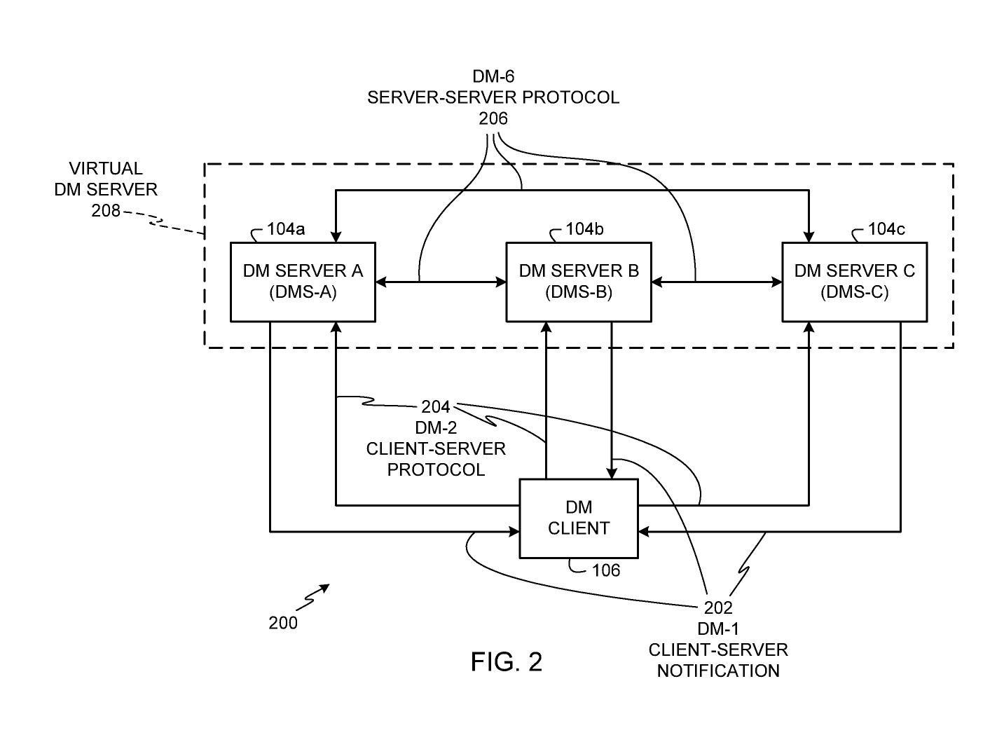

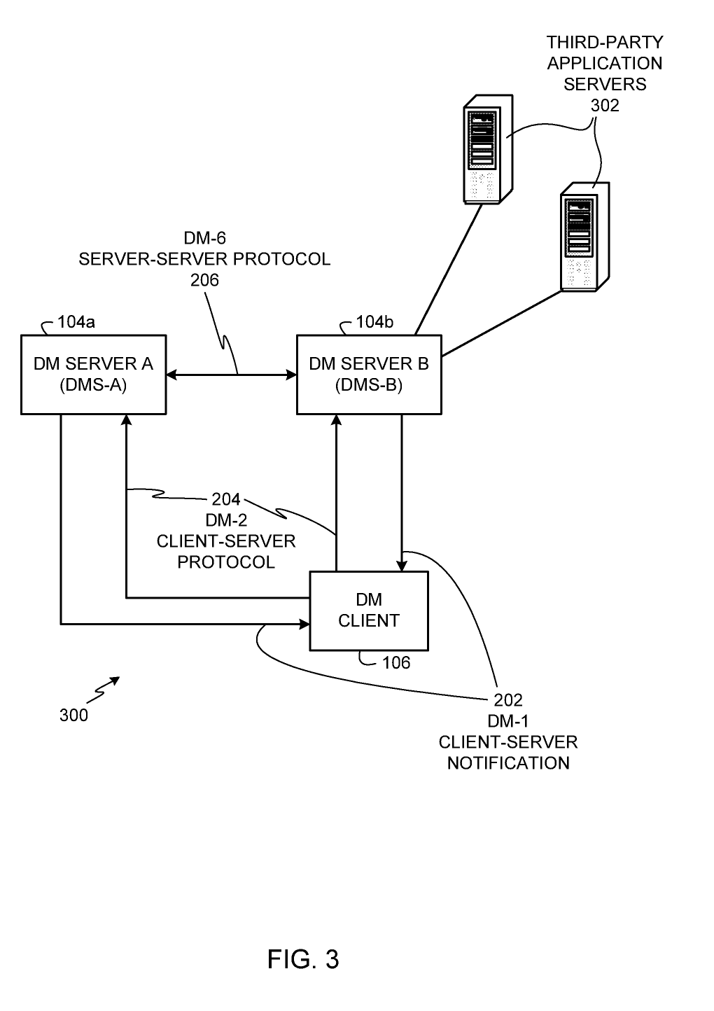

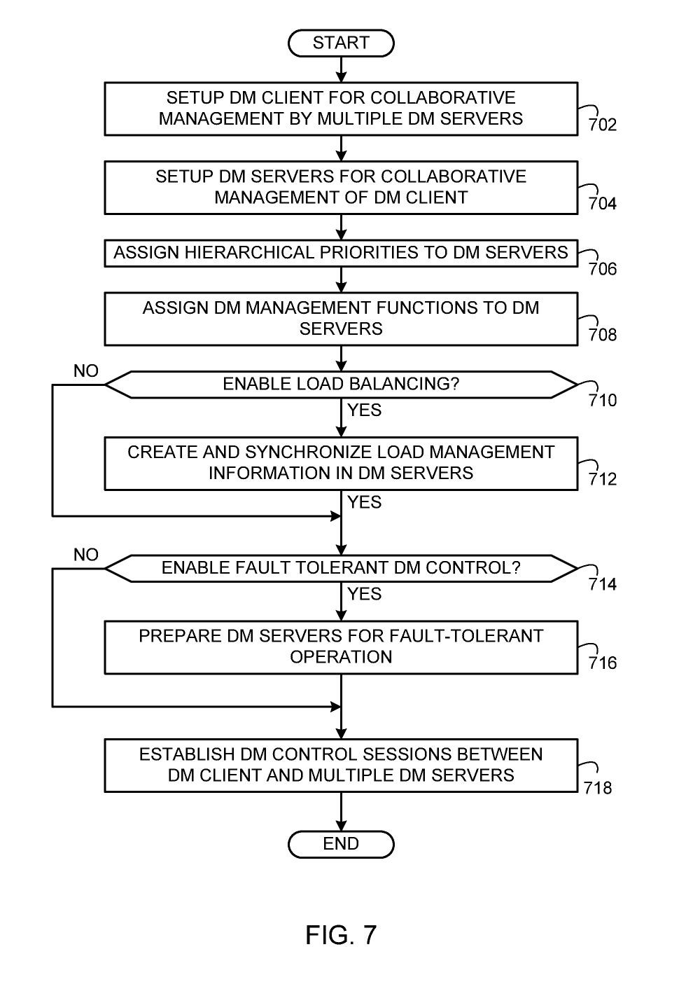

The example methods and apparatus described herein can be used to establish management sessions between multiple DM servers and a DM client, such that two or more of the DM servers 104a-c can share management of the DM client 106. In such example implementations, each of the DM servers 104a-c can have partial control capabilities assigned to it so that the combination of the DM servers 104a-c form full control over the DM client 106. Such a device management control architecture can be used to separate different types of control functions among different DM servers to, for example, balance loads among multiple servers and implement more security for device management control functions. Example device management architectures depicted in FIGS. 2 and 3 may be used to collaboratively manage a DM client or delegate management thereof using multiple DM servers. In addition, FIG. 7 depicts an example process that may be used to establish collaborative DM control sessions between multiple DM servers and a DM client.

In some example implementations, one of the DM servers 104a-c may be configured to delegate or transfer management of the DM client 106 to another one or more of the DM servers 104a-c to enable the other one or more of the DM servers 104a-c to establish a DM control session(s) with the DM client 106. For example, when the DM server A 104a is managing the mobile device 108 and the mobile device 108 is moved to another geographic location managed by the DM server B 104b or the DM server C 104c, a delegation process is initiated in which the DM server A 104a operates as the DM server delegator and the DM server B 104b or the DM server C 104c operates as the DM server delegatee to receive authority to manage the DM client 106. Example methods and apparatus to transfer or delegate management between DM servers are described in U.S. provisional patent application Ser. No. 61/320,125, filed concurrently with this application on Apr. 1, 2010, titled, “Methods and Apparatus to Transfer Management Control of a Client Between Servers,” by Axel Ferrazzini et al., and bearing attorney docket no. 38177-US-PRV, which is hereby incorporated by reference herein in its entirety.

Turning to FIG. 2, an example communication architecture 200 between the DM servers 104a-c and the DM client 106 of FIG. 1 is shown in connection with different notification and protocol interfaces that can be used to implement collaborative or delegation of device management between the DM servers 104a-c and the DM client 106. As shown, the DM servers 104a-c communicate with the DM client 106 using DM-1 client-server notification interfaces 202, and the DM client 106 communicates with the DM servers 104a-c using DM-2 client-server protocol interfaces 204. Example requirements and capabilities of the DM-1 client-server notification interfaces 202 and the DM-2 client-server protocol interfaces 204 can be found in the OMA specifications related to device management processes.

In the illustrated example of FIG. 2, the DM-1 client-server notification interfaces 202 are bearer neutral and can operate over different protocols such as wireless application protocol (WAP) push, HTTP, short message service (SMS) and session initiation protocol (SIP) push. The DM servers 104a-c can use the DM-1 client-server notification interfaces 202 to send device management notifications to DM clients.

In the illustrated example of FIG. 2, the DM-2 client-server protocol interfaces 204 can be used by the DM servers 104a-c to send device management commands to the DM client 106 and can be used by the DM client 106 to return status and alerts to the DM servers 104a-c. The DM-2 client-server protocol interfaces 204 are bearer neutral and provide standardized bindings including hypertext transfer protocol (HTTP) and secure HTTP (HTTPS). The DM-2 client-server protocol interfaces 204 may be exposed over an airlink-based data bearer protocol (e.g., general packet radio service (GPRS)) to provide over-the-air device management capability.

Also shown in FIG. 2 is a DM-6 server-server protocol interface 206 used to exchange management commands and responses between the DM servers 104a-c to coordinate management of the DM client 106 by the DM servers 106a-c. The DM-6 server-server protocol interface 206 enables DM servers to directly connect and interwork with each other to, for example, establish hierarchies (e.g., priority hierarchies) of DM client management between multiple DM servers, establish agreements for partial or shared management of DM clients between multiple DM servers, extend user services and business-to-business services, load share among multiple DM servers, and maintain fault-tolerant architectures between multiple DM servers. The DM-6 server-server protocol interface 206 is bearer neutral and provides standardized bindings including HTTP and HTTPS. Preferably, but not necessarily, HTTPS can be used for security reasons.

In the illustrated example of FIG. 2, when two or more of the DM servers 104a-c are granted authority or authorization to manage the DM client 106, the DM servers 104a-c may use the DM-6 server-server protocol interface 206 to negotiate or otherwise establish a hierarchy of priorities indicating the management priorities of the DM servers 104a-c relative to one another. Such priority rankings can involve assigning one of the DM servers 104a-c as a primary management authority (MA) for the DM client 106 and assigning others of the DM servers 104a-c as having secondary management authority. In such a hierarchy, the priorities can be defined so that while the secondary priority DM servers may be able to access and change minor characteristics of the DM client 106, only the primary DM server can make significant changes to the DM client 106. For example, a mobile communications network operator having a global presence (e.g., having DM servers located throughout multiple geographic locations throughout the world) may assign a primary-priority DM server (e.g., the DM server A 104a) in Europe to manage all European homed mobile devices (e.g., the mobile device 108 of FIG. 1) and a DM server (e.g., the DM server B 104b) located in North America as the secondary-priority DM server. Similarly in such an example implementation, the network operator could configure the North American DM server to operate as the primary-priority DM server for all North American homed mobile devices and the European DM server to operate as the secondary-priority DM server for those devices.

The DM-6 server-server protocol interface 206 can also be used to implement load sharing and fault-tolerant systems using two or more of the DM servers 104a-c connected and interworking with one another via the DM-6 server-server protocol interface 206. For example, the DM servers 104a-c can use the DM-6 server-server protocol interface 206 to transfer or delegate management function responsibilities among one another to form, for example, a virtual DM server 208. In this manner, the workloads for managing the DM client 106 can be at least one of delegated, distributed and shared among the DM servers 104a-c to enable load balancing and reducing the likelihood that any one of the DM servers 104a-c becomes overloaded. During failure events of any of the DM servers 104a-c, control functions previously handled by the failing DM server can be assumed by the non-failing DM servers so that management of the DM client 106 continues relatively uninterrupted. In this manner, such a fault-tolerant system enables increasing operational reliability of mobile devices (e.g., the mobile device 108 of FIG. 1) by substantially reducing or eliminating instances of service unavailability.

FIG. 3 is another example device management architecture 300 that may be used to establish a DM session with the DM client 106 to manage third-party application servers 302 separately from other types of DM sessions associated with other control functions for the DM client 106. Mobile devices (e.g., the mobile device 108 of FIG. 1) receive many of their services through network operators supplying the network services for those mobile devices. However, as third-party applications become available for mobile devices, the example methods and apparatus described herein can enable network operators to have control over such third-party services to substantially reduce or eliminate the likelihood of such third-party services having a negative impact on the performance, reliability, or stability of their networks.

In the illustrated example of FIG. 3, the DM server B 104b is in communication with the third-party application servers 302 that provide services or underlying functionality to applications resident on mobile devices (e.g., the mobile device 108 of FIG. 1). In operation, DM servers (e.g., the DM servers 104a-c) should be highly secure to maintain performance, reliability, and stability of networks. Thus, establishing external links between the third-party application servers 302 and a DM server that also operates as the main DM server managing all aspects of mobile devices on a network introduces a certain amount of risk that those third-party application servers 302 will create a security vulnerability for intentional or accidental infiltration into the operations of the network. To reduce or eliminate such security vulnerabilities, while still providing management of third-party applications and services, the example methods and apparatus described herein can be used to separate the types of management functions performed by different DM servers for a particular DM client (e.g., the DM client 106). For example, a network operator can separate management of operator-specific operations, administration, and management (OA&M) features such as creating/maintaining network radio parameters and billing from a DM server that is responsible for managing external third-party applications and services.

In the illustrated example of FIG. 3, the DM server A 104a is configured to perform OA&M functions, while the DM server B 104b is configured to be dedicated to managing and controlling third-party applications or services offered by the third-party application servers 302. To enable the dedicated management of third-party applications and services, the DM client 106 can be provided with a Software Component Management Object (SCoMO) and the DM server B 104b can be designated as a SCoMO server. A SCoMO enables management authorities (e.g., the DM servers 104a-c) to deliver, update, and remove software components in a secure environment. In particular, SCoMOs define the structures and contents of device management trees so that software components installed in mobile devices (e.g., the mobile device 108 of FIG. 1) can be managed remotely.

In operation, the DM server A 104a can interact with the DM server B 104b via the DM-6 server-server protocol interface 206 to provide, for example, firmware updates to the mobile device 108 (FIG. 1), associated with the DM client 106, that would allow the mobile device 108 to download or otherwise use new applications from the third-party application servers 302. Thus, the DM-6 server-server protocol interface 206 allows additional services and applications (e.g., future and extended services and applications) to be available to a DM client, while preserving a relatively high level of security for client management aspects of a network.

In the illustrated example implementations described herein, the DM servers 104a-c use the DM client 106, a DM management tree object, a DM account management object (DMAcc MO), and associated access control lists (ACLs) to implement delegation or collaborative management of the DM client 106 by multiple ones of the DM servers 104a-c and/or other DM servers (not shown).

The structures and syntaxes of DM management tree objects, DMAcc MOs, and ACLs are specified in the OMA specifications related to device management processes. In example implementations associated with OMA DM, each device (e.g., the mobile device 108 of FIG. 1) that supports OMA DM contains or stores a management tree for a DM client of the device. The management tree organizes the available management objects (MOs) in the device as nodes in a hierarchical tree structure where each of the nodes can be uniquely addressed with a universal resource identifier (URI). Each node can be manipulated (or nodes can be added or removed) by a DM server (e.g., one of the DM servers 104a-c of FIGS. 1-3) using management actions carried over an OMA DM protocol (e.g., the DM-2 client-server protocol interfaces 204 of FIGS. 2 and 3). During runtime, a DM server can explore a management tree of a DM client using a GET command and extend or otherwise modify the management tree using ADD or REPLACE commands. In addition, a DM client can extend its management tree based on user input or in response to attachment of an accessory (e.g., a removable memory, an I/O add-on device, etc.) to the device.

Devices compliant with OMA DM (e.g., the mobile device 108 of FIG. 1) support DMAcc MOs to store settings for communications via a DM protocol (e.g., the DM-2 client-server protocol interfaces 204 of FIGS. 2 and 3) with or by the DM client (e.g., the DM client 106). Such settings include login credentials that the DM client uses to authorize access by DM servers. In the illustrated examples described herein, when DM servers (e.g., the DM servers 104a-c) share management of a DM client (e.g., the DM client 106), the DM servers create a new DMAcc in the DM client to allow the DM servers to establish DM control sessions with the DM client for simultaneous or concurrent control over the DM client.

Devices compliant with OMA DM (e.g., the mobile device 108 of FIG. 1) also support ACLs. An ACL is a node property of a DM management tree object and is used to grant access rights to server identifiers of DM servers (e.g., the DM servers 104a-c of FIG. 1) to access a DM client (e.g., the DM client 106 of FIG. 1) or a specific node or nodes of the DM tree associated with a DM client. An ACL can grant access permissions to DM servers on a per-command basis. For example, to allow a particular command (e.g., open a DM control session) to be issued by the DM server B 104b to the DM client 106, an ACL of the DM client 106 associates the server identifier of the DM server B 104b to the particular command. Without the server identifier of the DM server B 104b being associated or assigned to the command, the DM server B 104b is not authorized to issue the command to the DM client 106. While establishing multiple management authority over the DM client 106, the DM server A 104a can transfer or delegate management of the DM client 106 by modifying the ACL of the DM client 106 for the server(s) that are intended to manage the DM client 106. In this manner, the DM server B 104b and/or the DM server C 104c is/are allowed to collaboratively manage the client by the DM server 104a, the DM server B 104b, and/or the DM server C 104c.

When management of a DM client is transferred or delegated to multiple DM servers, the ACLs of the DM client can be updated to indicate a hierarchical control structure for the multiple DM servers to indicate the ordering of management priority (e.g., primary priority, secondary priority, tertiary priority, etc.) allocated to each of the DM servers. In addition, the ACLs of the DM client may be updated to indicate a default DM server. The priority and default information can be used by the DM client to communicate information to a DM server when it has multiple DM servers to choose from. In this manner, the DM client need not communicate the same information to more than one DM server to ensure that all of the DM servers are synchronized. Instead, the information communicated by the DM client to one of the DM servers can be synchronized to the other DM servers without involvement by the DM client for such synchronization.

To enable sharing of client management functions, the ACL for each node of a DM management tree object is modified to show a list of DM servers that have permissions to modify that node. Preferably, but not necessarily, the amount of information used to specify such permissions in each node is kept to a minimum through the use of, for example, coded values or symbols. In this manner, ACLs remain manageable on the mobile device 108, even when many DM servers are given control of a node. In addition, inheritance rules for node authority can be configured so that a subsequent node does not automatically inherit permissions from a previous node. In this manner, permissions cannot accidentally be granted to a subsequent node corresponding to a different DM server. Instead, a permission in a node must be explicitly granted.

The example methods and apparatus described herein for delegating or collaborative management can be implemented using DMAcc MOs by storing data relevant to a particular DM server in a corresponding DMAcc MO and modifying the nodes of the DMAcc MO to configure the permissions or behavior of the DM server. The example methods and apparatus described herein do not require a DM client to store data needed for server-to-server communications and negotiations. Thus, a new DM management tree object may be defined (e.g., ./DMServer/ . . . ) specific to server-to-server communications over the DM-6 server-server protocol interface 206. In the illustrated example implementations described herein, the new server-to-server DM management tree object is not stored on a DM client (e.g., the DM client 106), but is instead stored separately (e.g., in a DM server) from the DM management tree object information associated with the DM client.

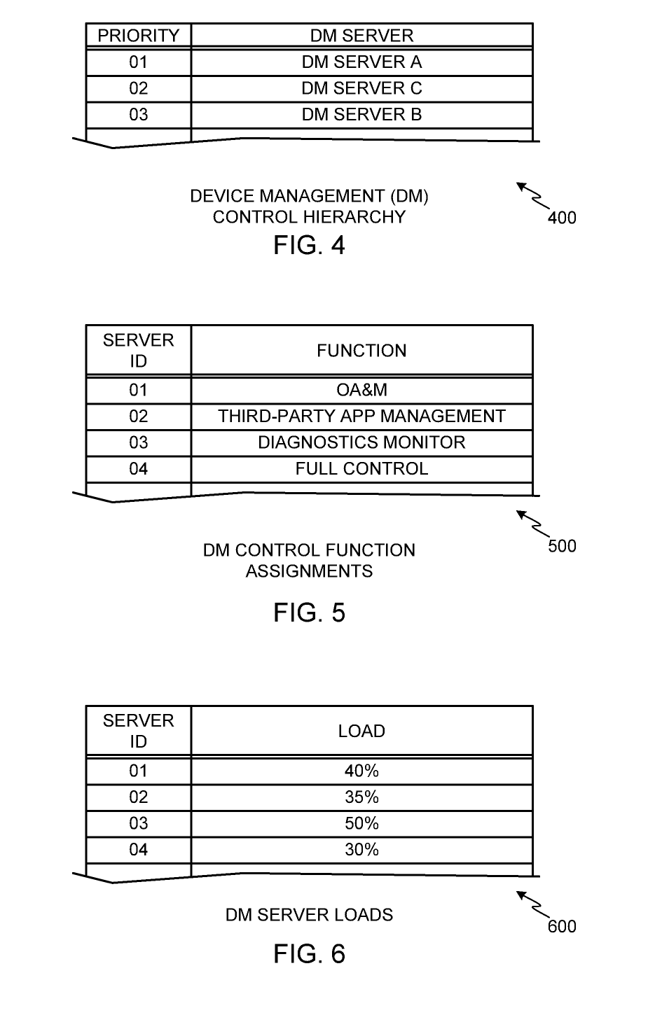

FIG. 4 is an example DM control hierarchy data structure 400 that specifies priorities associated with the DM servers 104a-c of FIGS. 1-3 managing the DM client 106 of FIG. 1. The information in the DM control hierarchy data structure 400 can be stored in a server DM management tree object and synchronized across the DM servers 104a-c via the DM-6 server-server protocol interface 206 of FIGS. 2 and 3 to inform each of the DM servers 104a-c of their priority rankings for a particular collaborative DM control management session.

FIG. 5 is an example DM control function assignments data structure 500 that specifies functions associated with respective ones of the DM servers 104a-c of FIGS. 1-3. The information in the DM control function assignments data structure 500 can be stored in a server DM management tree object and synchronized across the DM servers 104a-c via the DM-6 server-server protocol interface 206 of FIG. 2 to inform each of the DM servers 104a-c of their respective delegated functions for a particular collaborative DM control management session. In some example implementations, more than one function may be assigned to a single one of the DM servers 104a-c. If any of the DM servers 104a-c fails, the function(s) of the failing DM server can be delegated to one or more of the non-failing servers and re-assigned in the server DM management tree object. In the illustrated example, the DM control function assignments data structure 500 shows an OA&M function, a third-party application management function, a diagnostics monitor, and full control. However, other functions (e.g., device connection management) may also be designated in addition to or instead of the functions depicted in FIG. 5.

FIG. 6 is an example DM server loads data structure 600 that tracks the work loads of each of the DM servers 104a-c of FIGS. 1-3 for use in balancing loads between the DM servers 104a-c. The load status information for each of the DM servers 104a-c indicated in the DM server loads data structure 600 can be stored and updated in a server DM management tree object and synchronized across the DM servers 104a-c via the DM-6 server-server protocol interface 206 of FIGS. 2 and 3 to inform each of the DM servers 104a-c of the workloads for one another. In some example implementations, the load status information indicated in the DM server loads data structure 600 can be collective loads associated with managing all DM clients assigned to each of the DM servers 104a-c, while in other example implementations, the load status information can be loads of the DM servers 104a-c associated with managing only a single DM client (e.g., the DM client 106). In any case, the DM servers 104a-c (or a primary-priority DM server) can be provided with a monitor-delegator to analyze the relative workloads of the DM servers 104a-c and ensure that functions are re-delegated to different DM servers whenever a DM server is relatively over-loaded.

FIG. 7 depicts a flow diagram representative of an example process that may be implemented using computer readable instructions to establish multiple DM control sessions between the DM servers 104a-c and the DM client 106 of FIGS. 1-3 to delegate management or collaboratively manage the DM client 106 using multiple DM servers 104a-c. The example process of FIG. 7 may be performed using a processor, a controller and/or any other suitable processing device. For example, the example process of FIG. 7 may be implemented using coded instructions (e.g., computer readable instructions) stored on a tangible compute readable medium such as a flash memory, a read-only memory (ROM), and/or a random-access memory (RAM) or any other storage media (e.g., optical, magnetic, solid state, etc.) in which information is stored for any duration (e.g., for extended time periods, permanently, brief instances, for temporarily buffering, and/or for caching of the information). As used herein, the term tangible computer readable medium is expressly defined to include any type of computer readable storage medium and to exclude propagating signals.

Additionally or alternatively, the example process of FIG. 7 may be implemented using coded instructions (e.g., computer readable instructions) stored on a non-transitory computer readable medium such as a flash memory, a read-only memory (ROM), a random-access memory (RAM), a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, the example process of FIG. 7 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, the example process of FIG. 7 may be implemented manually or as any combination(s) of any of the foregoing techniques, for example, any combination of firmware, software, discrete logic and/or hardware. Further, although the example process of FIG. 7 is described with reference to the flow diagram of FIG. 7, other methods of implementing the process of FIG. 7 may be employed. For example, the order of execution of the blocks may be changed, and/or some of the blocks described may be changed, eliminated, sub-divided, or combined. Additionally, any or all of the operations of the example process of FIG. 7 may be performed sequentially and/or in parallel by, for example, separate processing threads, processors, devices, discrete logic, circuits, etc.

Turning in detail to FIG. 7, initially, one of the DM servers 104a-c (e.g., DM server A 104a) sets up the DM client 106 for collaborative management by multiple DM servers (e.g., the DM servers 104a-c) (block 702). For example, the DM server A 104a may create DMAcc MOs and modify ACLs for itself and each of the other DM servers 104b-c that will manage the DM client 106. The DM server A 104a sets up itself and the DM servers 104b-c for collaborative management of the DM client 106 (block 704). For example, the DM server A 104a can create (or update) server DM management tree objects for itself and each of the DM servers 104b-c to specify how the DM servers 104a-c will connect and interwork with one another to collaboratively manage the DM client 106.

The DM server A 104a assigns hierarchical priorities to itself and the DM servers 104b-c (block 706). For example, the DM server A 104a can store priority information (similar to the priority information in the example DM control hierarchy data structure 400 of FIG. 4) into the server DM management tree objects of itself and the DM servers 104b-c. The DM server A 104a assigns management functions to itself and the respective DM servers 104b-c (block 708). For example, the DM server A 104a can store management function assignments (similar to the function assignments of the DM control function assignments data structure 500 of FIG. 5) in the server DM management tree objects of itself and the DM servers 104b-c.

The DM server A 104a determines whether to enable load balancing (block 710). For example, load balancing may be enabled by a network operator if the network operator desires to have the DM servers monitor and re-distribute workloads among one another, when necessary. If load balancing is to be enabled (block 710), the DM server A 104a creates and synchronizes load management information among itself and the DM servers 104b-c (block 712). For example, the DM server A 104a can create entries for load status information (similar to the load status information of the DM server loads data structure 600 of FIG. 6) in the server DM management tree objects of itself and the DM servers 104b-c.

After creating and synchronizing load management information (block 712) or if load balancing is not enabled (block 710), the DM server A 104a determines whether to enable fault-tolerant DM control (block 714). For example, fault-tolerant DM control operation may be enabled by a network operator if the network operator desires to automatically switchover management function responsibilities to non-failing DM servers upon the failure of one or more DM servers. If fault-tolerant DM control is to be enabled (block 714), the DM server A 104a prepares itself and the other DM servers 104b-c for fault-tolerant operation (block 716) using any known fault-tolerant techniques (e.g., inter-server data synchronization). In this manner, any non-failing ones of the DM servers 104a-c can assume control over the DM client 106 upon failure of any other one(s) of the DM servers 104a-c.

After preparing the DM servers 104a-c for fault tolerant operation or if fault-tolerant operation is not to be enabled (block 714), the DM servers 104a-c establish respective control sessions with the DM client 106 (block 718) to collaboratively manage the DM client 106 via a collaborative DM control management session. The example process of FIG. 7 then ends.

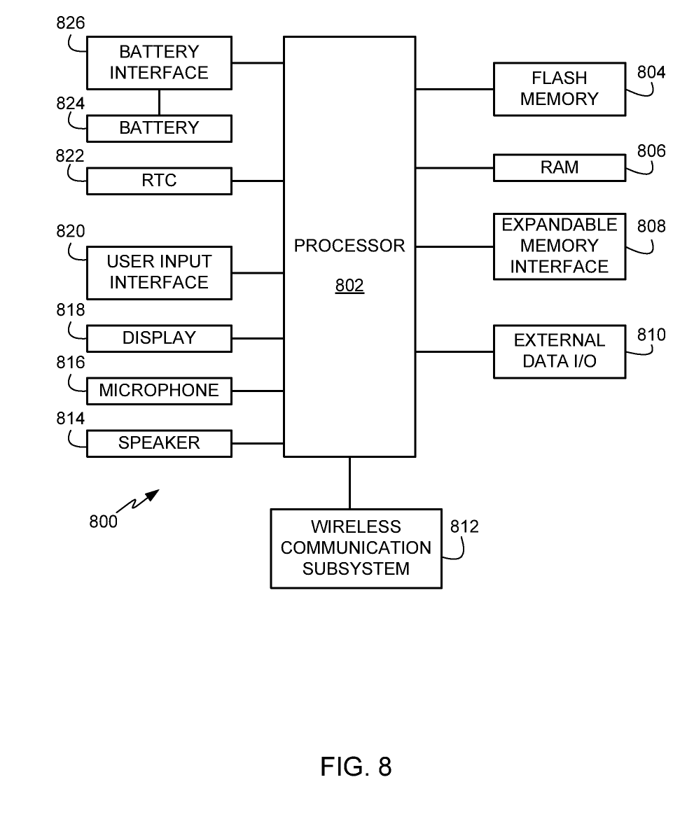

FIG. 8 depicts an example computing device 800. In some instances, the computing device 800 may be adapted and configured as a server device which implements a DM server (e.g., the DM servers 104a-c). In other instances, the computing device 800 of FIG. 8 may be configured as the mobile device 108 of FIG. 1 which implements a DM client. In the illustrated example, the device 800 includes a processor 802 that may be used to control the overall operation of the device 800. The processor 802 may be implemented using a controller, a general purpose processor, a digital signal processor, dedicated hardware, or any combination thereof.

The device 800 is provided with a FLASH memory 804, a random access memory (RAM) 806, and an expandable memory interface 808 communicatively coupled to the processor 802. The FLASH memory 804 can be used to, for example, store computer readable instructions and/or data. In some example implementations, the FLASH memory 804 can be used to store information stored in DM management tree objects associated with a DM client, ACLs, and DMAcc MOs and computer readable instructions to implement the DM client 106 of FIGS. 1-3. The RAM 806 can also be used to, for example, store data and/or instructions. The device 800 is also provided with an external data I/O interface 810. The external data I/O interface 810 may be used by a user to transfer information to and from the device 800 through a wired medium.

The device 800 is provided with a wireless communication subsystem 812 to enable communications with networks such as the mobile communication networks 102a-c of FIG. 1. In the illustrated examples described herein, the communication subsystem 812 can be configured in accordance with a cellular communication standard. In other example implementations, the communication subsystem 812 can be implemented using an IEEE® 802.11 standard, a BLUETOOTH® radio, a ZIGBEE® device, a wireless USB device, or an ultra-wideband (UWB) radio (e.g., WiMax). However, the communication subsystem 812 may also facilitate wired communications between the device 800 and a local area network (LAN) and the like.

To enable a user to use and interact with or via the device 800 when it is configured as the mobile device 108, the device 800 is provided with a speaker 814, a microphone 816, a display 818, and a user input interface 820. The display 830 can be an LCD display, an e-paper display, etc. The user input interface 820 could be an alphanumeric keyboard and/or telephone-type keypad, a multi-direction actuator or roller wheel with dynamic button pressing capability, a touch panel, etc. As discussed above, the example methods and apparatus described herein can also be advantageously used in connection with wireless terminals that do not have user interfaces and, thus, the speaker 814, the microphone 816, the display 818, the user input interface 820, and/or any combination thereof may be optionally omitted.

The device 800 is also provided with a real-time clock (RTC) 822 to track dates and a current time of day and/or to implement time-based and/or date-based operations (e.g., identifying the expiration of temporary delegation key). In the illustrated example, the mobile device 108 is a battery-powered device and is, thus, provided with a battery 824 and a battery interface 826. However, the device 800 may receive voltage and current via another source such as direct current or alternating current power outlets and the like.

International Patent Application No. PCT/US11/29820, filed on Mar. 24, 2011, and U.S. provisional application No. 61/320,116, filed on Apr. 1, 2010, are hereby incorporated by reference herein in their entireties.

Although certain methods, apparatus, and articles of manufacture have been described herein, the scope of coverage of this disclosure is not limited thereto. To the contrary, this disclosure covers all methods, apparatus, and articles of manufacture fairly falling within the scope of the claims either literally or under the doctrine of equivalents.

What is claimed is:

1. A device comprising:
a processor configured to execute an Open Mobile Alliance (OMA) Device Management (DM) server,
wherein the OMA DM server uses or includes an interface to send communications directly to a second OMA DM server for delegating management of a DM client.

2. The device of claim 1 wherein the interface is bearer neutral.

3. The device of claim 1 wherein the interface provides at least one binding selected from HTTP or HTTPS.

4. The device of claim 1 wherein the interface facilitates at least one of load-balancing or fault-tolerant management of the DM client.

5. A tangible computer-readable medium storing instructions which, when performed, cause a device to execute an Open Mobile Alliance (OMA) Device Management (DM) server configured to perform an operation of:
delegating management of a DM client to a second OMA DM server by sending communications, via an interface, directly to the second OMA DM server.

6. The computer-readable medium of claim 5 wherein the interface is bearer neutral.

7. The computer-readable medium of claim 5 wherein the interface provides at least one binding selected from HTTP or HTTPS.

8. The computer-readable medium of claim 5 wherein delegating facilitates at least one of load-balancing or fault-tolerant management of the DM client.
